(19) United States
(12) Patent Application Publication
(10) Pub. No.: US 2026/0288442 A1
(43) Pub. Date: Sep. 24, 2026

(54) Method and Apparatus for Controlling Software Updates in a Distributed Computing Environment

(71) Applicant: Crowdstrike, Inc., Sunnyvale, CA (US)

(72) Inventor: Hazim AVDAL, Cincinnati, OH (US)

(21) Appl. No.: 19/088,706

(22) Filed: Mar. 24, 2025

(51) Int. Cl. G06F 8/65

(52) U.S. Cl. CPC G06F 8/65

(57) ABSTRACT

A deployment strategy is defined for a feature on a plurality of computer systems in a distributed computing environment, including an action to take with respect to the feature, a portion of the computer systems to which to apply the deployment strategy, a time at which to start applying the deployment strategy to the portion of the plurality of computer systems, a duration of time over which to apply the deployment strategy to the portion of the plurality of computer systems and a formula for accelerating application of the deployment strategy to the portion of the plurality of computer systems over the duration of time. Executing logic implements the deployment strategy for the feature on the portion of the plurality of computer systems, including selecting which portion of the plurality of computer systems to which to apply the deployment strategy for the feature.

### COPYRIGHT NOTICE

A portion of this disclosure contains material which is subject to copyright protection. The copyright owner has no objection to the facsimile reproduction by anyone of the disclosure as it appears in the Patent and Trademark Office patent file or records, but otherwise reserves all copyright rights whatsoever.

### TECHNICAL FIELD

Embodiments relate to hardware or software feature or function deployment strategies in large-scale distributed computing environments.

### BACKGROUND

A faulty computer update, such as a faulty software update, particularly when attempted in a large-scale distributed computing environment, can wreak disruption, havoc and chaos across multiple industries, especially if the affected computer systems are running critical operations. Traditional software updates involve rolling out all at once to all subscribers one or more new features, functions, or revisions in the software. A problem with the update for one subscriber can be a problem for all subscribers, amplifying the effect.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a flowchart of aspects of a computer-implemented method according to an embodiment of the invention.

FIG. 2 is a flowchart of aspects of a computer-implemented method according to an embodiment of the invention.

FIG. 3 is an example declaration of a feature deployment strategy according to the disclosed embodiments.

FIG. 4 illustrates an example architecture for a computing device capable of carrying out an embodiment of the invention.

### DETAILED DESCRIPTION

The disclosed embodiments provide for gradual and controlled software change deployments in large-scale distributed computing systems, addressing the limitations of traditional binary feature flags, where a feature is either on/enabled or off/disabled, for all subscribers, by introducing a more nuanced and automated deployment mechanism.

The disclosed embodiments define and execute complex software change rollout patterns based on various parameters such as one or more of time, traffic volume, and performance metrics. Unlike conventional software change rollout methods that rely on manual selection of test groups, the disclosed embodiments employ algorithmic decision-making to determine software feature availability, for each computer system, user, or transaction, in real-time.

The disclosed embodiments may use a declarative configuration language for defining software change rollout strategies, and application of the same to specific software features, allowing developers to specify, for example, gradual percentage-based deployments, time-bounded activations, and context-sensitive feature enabling, as discussed below.

An automated execution engine interprets, in real-time, the declarative configurations and dynamically computes software feature availability accordingly.

Some embodiments employ built-in resiliency measures that can automatically halt, or reverse software deployments based on predefined performance thresholds.

The disclosed embodiments significantly enhance the safety and efficiency of software feature change deployments in high-traffic, mission-critical systems by reducing the risk of widespread issues and enabling more granular control over the rollout process.

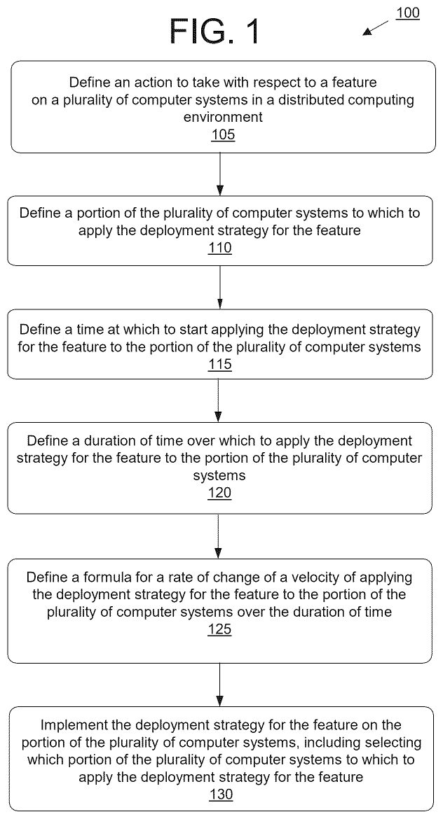

The disclosed embodiments, with reference to FIG. 1, involves a computer-implemented method 100, performed by a computing device having at least a memory in which to store executable instructions and a processing unit to read and execute the instructions according to the computer-implemented method. The computing device communicates with all the other computers or internet-connected devices in the distributed computing environment. The number of such computers or devices could be just a handful or may include tens of thousands of computers. In particular, the computing device can communicate with the other computers to change a configuration on the other computers, such as to change a hardware and or software configuration, function, or feature, on the other computers.

According to the disclosed embodiments, the computing device receives user input at logic blocks 105-125 to define a deployment strategy for a feature on a plurality of computer systems in a distributed computing environment. According to an embodiment, the computer device receives at logic block 105 user input specifying an action to take with respect to the feature. For example, the feature may be a software feature, and the action to take with respect to the feature may be to add, remove, enable, disable, or modify the feature. According to an embodiment, the feature may be a functional, operational, technical, or other features. A functional feature may involve what a computer system can do, for example, application software features. Operational features may involve how the computer system runs, for example, operating system functionality and features. Technical features may involve how the computer system is configured, for example, enabling or disabling a hardware or software component.

The computer device at logic block 110 defines a deployment strategy for a feature. For example, the computer device may receive at logic block 110 user input specifying a portion of the plurality of computer systems to which to apply the deployment strategy for the feature. For example, the user may specify an absolute number of computer systems, such as one, ten, 100, 1000, or more computer systems. Similarly, the user may specify a percentage of the plurality of computer systems, such as 10%, 25% or 100% of all computer systems in the distributed computing environment.

Alternatively, a deployment strategy could be applied to a plurality of computer systems based on known performance indicators (KPIs) for the distributed computing environment, and/or the plurality of computer systems. To do so, the disclosed embodiments monitor and analyze KPIs, such as traffic volume associated with selected types of users, certain types of transactions, or event or alert traffic volume, as measured by the number of the events or alerts transmitted by a respective sensor associated with each of the plurality of computer systems in the computing environment to a cybersecurity service provider platform per unit of time. In such an embodiment, pre-defined thresholds may be configured by the user, and if such thresholds are exceeded, such as excessive error rates, excessive latency spikes, or event or alert traffic volume reaching or exceeding the capacity of consumer services on the cybersecurity service provider platform to timely process such traffic in real-time, then the deployment of the feature can be paused, or even reversed. This self-regulating aspect of the disclosed embodiments ensures that potential issues are detected and mitigated relatively quickly, without requiring manual intervention. Additionally, the disclosed embodiments can make additional use of the monitoring and analysis by providing detailed analytics on the deployment process, allowing developers and service providers to gain insights into feature adoption rates and impact on computer system distributed computing environment performance in real-time.

According to an embodiment, the computer device receives at logic block 115 user input specifying a time at which to start applying the deployment strategy for the feature to the portion of the plurality of computer systems, and at logic block 120, user input may be received defining a duration of time over which to apply the deployment strategy for the feature to the portion of the plurality of computer systems.

At logic block 125, a formula may be specified for a rate of change of a velocity of applying the deployment strategy for the feature to the portion of the plurality of computer systems over the duration of time. For example, a user may specify linear acceleration of the deployment of the feature of the duration or period of time specified by the user at logic block 120. For example, the user may specify deployment of a feature over a 30-minute period, starting at 0% and linearly increasing deployment of the feature to 25% of computers, or users, or transactions, over that 30-minute period of time. Other acceleration curves may be specified as well, such an exponential or logarithmic acceleration curve.

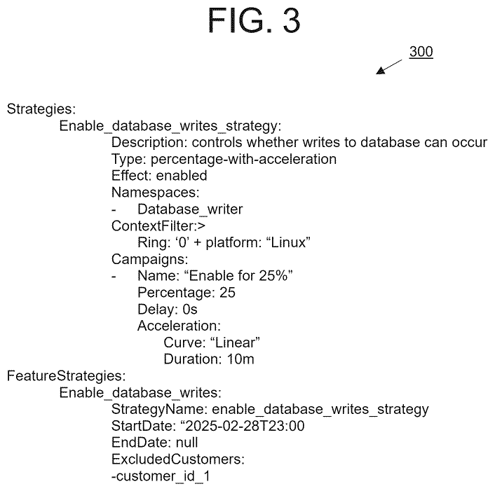

FIG. 3 provides an example embodiment 300 of a declarative language that may be used to specify the inputs in logic blocks 105-125. The example includes a definition for a strategy to control whether a database write can occur. The strategy enables database writes for 25% of the computer systems in the distributed computing environment, to be achieved over a 10-minute time period according to a linear acceleration curve. The example further shows a start date for applying the deployment strategy to enable database writes.

Referring again to FIG. 1, at logic block 130, an execution engine operating on a computing device can act on or implement the deployment strategy for a given feature. According to one embodiment, the input defining the deployment strategy for the feature is provided in the form of a declarative language that can be interpreted by an execution engine to make real-time decisions to deploy a feature. Thus, the execution engine can effect the deployment strategy for the feature on the portion of the plurality of computer systems, including selecting exactly which portion of the plurality of computer systems to which to apply the deployment strategy for the feature.

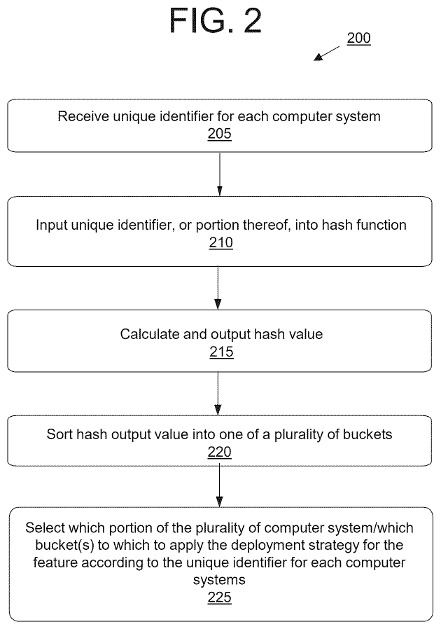

With reference to FIG. 2, according to an embodiment 200, the executing logic receives at logic block 205 a unique identifier for each computer system in the distributed computing environment and selects at logic block 225 the computer systems to which to apply the deployment strategy for the feature according to the unique identifier for each computer system.

One way to accomplish this is for the executing logic to input the unique identifier for each computer system into a hash function at logic block 210. The unique identifier for each computer may be any such identifier, for example, a Media Access Control (MAC) address, an IP address, or a cybersecurity sensor identifier, or a respective portion thereof, e.g., the OUI portion of a MAC address, the network prefix of an IP address, or the customer identifier (CID) associated with a cybersecurity endpoint sensor.

The hash function calculates a hash value at logic block 215 which can then be added to a bucket at logic block 220. The number of buckets can vary according to the extent to which the user wishes to shard or divide the computer systems in the distributed computing environment into different buckets. For example, the hash values could be divided among 100 buckets, giving the disclosed embodiments the ability to select 1% of computer systems at a time to which to deploy the feature. The deployment strategy can decide which bucket, in which order, gets selected for each 1% percent of the computer systems selected to receive the feature update.

The hashing function treats all computer systems as non-fungible devices. However, it is appreciated that some service providers may wish to prioritize to which computer systems to deploy a feature, and some customers may wish to wait to receive a feature update or avoid it altogether. Thus, with reference to FIG. 3, the declarative language allows for providing a context filter configuration. For example, the deployment strategy may be applied only to certain computer systems, such as those running a Linux-based operating system platform. The value of any computer system or distributed computing system attributes could be identified, and such value could be used to decide when to deploy a feature on a computer system. Additionally, or alternatively, a system of concentric rings may be used for rolling out updates. So, for example, the deployment strategy may be applied only to computer systems included in a particular ring, such as “Ring ‘0’”. In this manner, customers can choose their level of update adoption: early adopter (e.g., ring 0), general availability (e.g., ring 1), or opt-out/delay (as indicated by the excluded customers list in FIG. 3), etc.

The deterministic bucketing mechanism described above allows for every feature to be assigned a key and then the key is assigned to one or more of a plurality of buckets, say between 0 and 10,000, ensuring consistent behavior for specific (feature) keys. As described above, the disclosed embodiments may use a dynamic threshold within this range, which adjusts over time based on the acceleration curve defined in the deployment strategy for the feature. For instance, to enable a feature for 10% of traffic over a 2-hour period, the threshold gradually shifts over the 2-hour period from 0.00% to 10.00%. To enable the strategy, a feature check process deterministically uses the feature key to decide whether the associated feature should be enabled or disabled at any given moment, comparing it against the current threshold. This approach allows for precise control over the feature rollout process, enabling smooth, gradual deployments that can be fine-tuned to specific requirements.

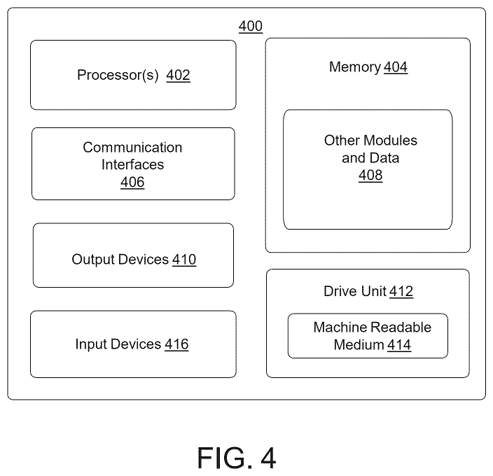

FIG. 4 depicts an example architecture for a computing device 400 that can carry out embodiments of the invention. The computing device 400 can be one or more computing devices, such as a client computing device, a workstation, a personal computer (PC), a laptop computer, a tablet computer, a personal digital assistant (PDA), a cellular phone, a media center, an embedded system, a server or server farm, multiple distributed server farms, a mainframe, or any other type of computing device. As shown in FIG. 4, computing device 400 can include processor(s) 402, memory 404, communication interface(s) 406, output devices 410, input devices 416, and/or a drive unit 412 including a machine readable medium 414.

In various examples, the processor(s) 402 can be a central processing unit (CPU), a graphics processing unit (GPU), or both CPU and GPU, or any other type of processing unit. Each of the one or more processor(s) 402 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 402 may also be responsible for executing drivers and other computer-executable instructions for applications, routines, or processes stored in the memory 404, which can be associated with common types of volatile (RAM) and/or nonvolatile (ROM) memory.

In various examples, the memory 404 can include system memory, which may be volatile (such as RAM), non-volatile (such as ROM, flash memory, etc.) or some combination of the two. Memory 404 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the computing device 400. Any such non-transitory computer-readable media may be part of the computing device 400.

The memory 404 can store data, including computer-executable instructions. The memory 404 can also store any other modules and data 408 that can be utilized by the computing device 400 to perform or enable performing any action taken by the computing device 400 or in connection with one or more user accounts. For example, the modules and data can be a platform, operating system, and/or applications, as well as data utilized by the platform, operating system, and/or applications.

The communication interfaces 406 can link the computing device 400 to other elements through wired or wireless connections. For example, communication interfaces 406 can be wired networking interfaces, such as Ethernet interfaces or other wired data connections, or wireless data interfaces that include transceivers, modems, interfaces, antennas, and/or other components, such as a Wi-Fi interface. The communication interfaces 406 can include one or more modems, receivers, transmitters, antennas, interfaces, error correction units, symbol coders and decoders, processors, chips, application specific integrated circuits (ASICs), programmable circuit (e.g., field programmable gate arrays), software components, firmware components, and/or other components that enable the computing device 400 to send and/or receive data, with the communication interfaces 406.

The output devices 410 can include one or more types of output devices, such as speakers or a display, such as a liquid crystal display. Output devices 410 can also include ports for one or more peripheral devices, such as headphones, peripheral speakers, and/or a peripheral display. In some examples, a display can be a touch-sensitive display screen, which can also act as an input device 416.

The input devices 416 can include one or more types of input devices, such as a microphone, a keyboard or keypad, and/or a touch-sensitive display, such as the touch-sensitive display screen described above.

The drive unit 412 and machine readable medium 414 can store one or more sets of computer-executable instructions, such as software or firmware, that embodies any one or more of the methodologies or functions described herein. The computer-executable instructions can also reside, completely or at least partially, within the processor(s) 402, memory 404, and/or communication interface(s) 406 during execution thereof by the computing device 400. The processor(s) 402 and the memory 404 can also constitute machine readable media 414.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other modulated data signals, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-3. Generally, computer-readable instructions include routines, programs, objects, components, data structures, and the like that perform functions or implement abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, performed by a computing device having at least a
memory in which to store executable instructions and a processing unit to read and execute the instructions according to the computer-implemented method, comprising:
defining a deployment strategy for a feature on a plurality of computer systems in a distributed computing environment, the deployment strategy specifying:
an action to take with respect to the feature;
a portion of the plurality of computer systems to which to apply the deployment strategy for the feature;
a time at which to start applying the deployment strategy for the feature to the portion of the plurality of computer systems;
a duration of time over which to apply the deployment strategy for the feature to the portion of the plurality of computer systems; and
a formula for a rate of change of a velocity of applying the deployment strategy for the feature to the portion of the plurality of computer systems over the duration of time; and
executing logic to effect the deployment strategy for the feature on the portion of the plurality of computer systems, including selecting which portion of the plurality of computer systems to which to apply the deployment strategy for the feature.

2. The method of claim 1, wherein defining the deployment strategy for the feature, specifying the action to take with respect to the feature, comprises one of adding, removing, enabling, disabling, and modifying the feature.

3. The method of claim 1, wherein defining the deployment strategy for the feature, comprises defining the deployment strategy for a functional, operational, or technical feature.

4. The method of claim 1, wherein defining the deployment strategy for the feature, comprises defining the deployment strategy for a software or hardware feature.

5. The method of claim 1, wherein defining the deployment strategy for the feature, including specifying the portion of the plurality of computer systems to which to apply the deployment strategy for the feature, comprises selecting one of: an absolute number of the plurality of computer systems, a percentage of the plurality of computer systems, a number of the plurality of computer systems based on known performance indicators (KPIs) for the distributed computing environment, or the plurality of computer systems.

6. The method of claim 1, wherein defining the deployment strategy for the feature, including specifying the formula for the rate of change of the velocity of applying the deployment strategy for the feature to the portion of the plurality of computer systems, comprises specifying one of a linear, exponential, and logarithmic acceleration or deceleration curve for applying the deployment strategy for the feature to the portion of the plurality of computer systems.

7. The method of claim 1, wherein executing logic selecting which portion of the plurality
of computer systems to which to apply the deployment strategy for the feature, comprises:
receiving a unique identifier for each computer system; and
selecting which portion of the plurality of computer systems to which to apply the deployment strategy for the feature according to the unique identifier for each computer system.

8. A non-transitory computer-readable medium storing computer-executable instructions
that, when executed by one or more processors, cause the one or more processors to execute instructions, comprising:
defining a deployment strategy for a feature on a plurality of computer systems in a distributed computing environment, the deployment strategy specifying:
an action to take with respect to the feature;
a portion of the plurality of computer systems to which to apply the deployment strategy for the feature;
a time at which to start applying the deployment strategy for the feature to the portion of the plurality of computer systems;
a duration of time over which to apply the deployment strategy for the feature to the portion of the plurality of computer systems; and
a formula for a rate of change of a velocity of applying the deployment strategy for the feature to the portion of the plurality of computer systems over the duration of time; and
executing logic to effect the deployment strategy for the feature on the portion of the plurality of computer systems, including selecting which portion of the plurality of computer systems to which to apply the deployment strategy for the feature.

9. The non-transitory computer-readable medium of claim 8, wherein defining the deployment strategy for the feature, specifying the action to take with respect to the feature, comprises one of: removing, enabling, disabling, and modifying the feature.

10. The non-transitory computer-readable medium of claim 8, wherein defining the deployment strategy for the feature, comprises defining the deployment strategy for a functional, operational, or technical feature.

11. The non-transitory computer-readable medium of claim 8, wherein defining the deployment strategy for the feature, comprises defining the deployment strategy for a software or hardware feature.

12. The non-transitory computer-readable medium of claim 8, wherein defining the deployment strategy for the feature, including specifying the portion of the plurality of computer systems to which to apply the deployment strategy for the feature, comprises selecting one of: an absolute number of the plurality of computer systems, a percentage of the plurality of computer systems, a number of the plurality of computer systems based on known performance indicators (KPIs) for the distributed computing environment, or the plurality of computer systems.

13. The non-transitory computer-readable medium of claim 8, wherein defining the deployment strategy for the feature, including specifying the formula for the rate of change of the velocity of applying the deployment strategy for the feature to the portion of the plurality of computer systems, comprises specifying one of a linear, exponential, and logarithmic acceleration or deceleration curve for applying the deployment strategy for the feature to the portion of the plurality of computer systems.

14. The non-transitory computer-readable medium of claim 8, wherein executing logic
selecting which portion of the plurality of computer systems to which to apply the deployment strategy for the feature, comprises:
receiving a unique identifier for each computer system; and
selecting which portion of the plurality of computer systems to which to apply the deployment strategy for the feature according to the unique identifier for each computer system.

15. A computer system, comprising:
a memory to store computer-executable instructions;
one or more processors to read from the memory and execute the instructions, comprising:
defining a deployment strategy for a feature on a plurality of computer systems in a distributed computing environment, the deployment strategy specifying:
an action to take with respect to the feature;
a portion of the plurality of computer systems to which to apply the deployment strategy for the feature;
a time at which to start applying the deployment strategy for the feature to the portion of the plurality of computer systems;
a duration of time over which to apply the deployment strategy for the feature to the portion of the plurality of computer systems; and
a formula for a rate of change of a velocity of applying the deployment strategy for the feature to the portion of the plurality of computer systems over the duration of time; and
executing logic to effect the deployment strategy for the feature on the portion of the plurality of computer systems, including selecting which portion of the plurality of computer systems to which to apply the deployment strategy for the feature.

16. The computer system of claim 15, wherein defining the deployment strategy for the feature, specifying the action to take with respect to the feature, comprises one of:
adding, removing, enabling, disabling, and modifying the feature.

17. The computer system of claim 15, wherein defining the deployment strategy for the feature, comprises defining the deployment strategy for a software or hardware feature.

18. The computer system of claim 15, wherein defining the deployment strategy for the feature, including specifying the portion of the plurality of computer systems to which to apply the deployment strategy for the feature, comprises selecting one of: an absolute number of the plurality of computer systems, a percentage of the plurality of computer systems, a number of the plurality of computer systems based on known performance indicators (KPIs) for the distributed computing environment, or the plurality of computer systems.

19. The computer system of claim 15, wherein defining the deployment strategy for the feature, including specifying the formula for the rate of change of the velocity of applying the deployment strategy for the feature to the portion of the plurality of computer systems, comprises specifying one of a linear, exponential, and logarithmic acceleration or deceleration curve for applying the deployment strategy for the feature to the portion of the plurality of computer systems.

20. The computer system of claim 15, wherein executing logic selecting which portion of the
plurality of computer systems to which to apply the deployment strategy for the feature, comprises:
receiving a unique identifier for each computer system; and
selecting which portion of the plurality of computer systems to which to apply the deployment strategy for the feature according to the unique identifier for each computer system.
